(19) United States
(12) Patent Application Publication
(10) Pub. No.: US 2014/0305267 A1
(43) Pub. Date: Oct. 16, 2014

(54) No-Slip Screwdriver

(71) Applicant: Emile Baroody, Bethesda, MD (US)

(72) Inventor: Emile Baroody, Bethesda, MD (US)

(21) Appl. No.: 14/249,444

(22) Filed: Apr. 10, 2014

Related U.S. Application Data
(60) Provisional application No. 61/810,525, filed on Apr. 10, 2013.

(51) Int. Cl. B25B 15/00

(52) U.S. Cl. CPC B25B 15/001
USPC 81/461

(57) ABSTRACT

A no-slip screwdriver is provided. The present invention comprises a screwdriver having a plurality of protrusions extending perpendicularly from the blade faces. These protrusions bear against the interior walls of a screw head groove, preventing the blade from slipping or skidding when the device is in use. The protrusions increase the width of the screwdriver blade, giving the screwdriver blade less room to move within the screw head. The protrusions of the present invention may be provided in a variety of different configurations, including ridges and nubs. The present invention may further be provided in either flathead or Phillips head variations.

### CROSS REFERENCE TO RELATED APPLICATION

This application claims the benefit of U.S. Provisional Application No. 61/810,525 filed on Apr. 10, 2013 entitled “No Skidding Screwdriver.” The above identified patent application is herein incorporated by reference in its entirety to provide continuity of disclosure.

### BACKGROUND OF THE INVENTION

1. Field of the Invention

The present invention relates to screwdrivers or bits. More specifically, the present invention relates to screwdrivers or bits having protrusions or recesses on their tips that are adapted to provide increased frictional engagement between the tip of the device and the head of the fastener.

Using a screwdriver can potentially be a frustrating process because the thickness of the screwdriver blade rarely directly conforms to the width of the groove in the screwdriver head. Because the screwdriver blade is generally thinner than the groove, it can slip or skid while in use because the substantially flat, tapered surface of the blade head cannot evenly bear against the interior walls of the screw head groove and instead different amounts of force are applied to different portions of the interior walls of the screw head groove when the screwdriver is rotated. This differential application of force creates a tendency for the screwdriver blade to slip as rotational force is applied by the user. A screwdriver slipping from a screw can be frustrating, decrease work productivity, and in extreme cases even damage surrounding materials.

Several different types of screwdrivers have different types of means for reducing the occurrence of slipping or skidding. Many types of these screwdrivers use special blades having elongated portions that are specifically designed to interact with a corresponding screw head. While these devices greatly reduce the chance that a screwdriver will slip from a screw head during use, they only work with their specific corresponding screw head, making them completely useless when the user is confronted with a traditional screw head. Other types of screwdrivers or bit heads have elongated scraping grooves that are designed to bite into the screw heads, providing increased engagement between the blade and the screw head and therefore making it easier to extract the screw from material that it is embedded in. However, these types of screwdrivers or bits often irreversibly damage the screw head, making it a less than ideal choice in many circumstances.

The present invention provides a screwdriver that has a plurality of protrusions extending perpendicularly from the blade face surfaces, which create increased engagement between the blade and the screw head. This increased engagement reduces the potential for slipping or skidding of the screwdriver blade. The protrusions extending from opposing blade faces bear against the interior walls of the screw head groove, providing a tighter fit for the screwdriver blade so that there is less potential for the blade to move therein. The protrusions also create an even distribution of force along the faces of the blade.

2. Description of the Prior Art

Devices have been disclosed in the prior art that relate to screwdrivers or drill bits having surfaces for generating increased friction between the bladed portion and the head of the fastener. These include devices that have been patented and published in patent application publications. These devices generally relate to bits or screwdriver blades having protrusions extending axially from the tip or recesses cut into the tip. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 4,434,687 to Vickio, which discloses a screwdriver adapted to remove damaged screws. Vickio provides a screwdriver having an axially-disposed, square protrusion extending from the end of the blade portion of the screwdriver. Furthermore, there are end surfaces that flank the protrusion extending from the blade portion that are beveled in the direction of the counterclockwise rotation. This design creates sharp leading edges that are able to dig into the damaged screw, thereby providing increased engagement with the screw head. The device is used by placing the blade of the screwdriver within the head of the damaged screw, applying blows to the handle head of the screwdriver to set the axially-disposed protrusion and beveled edges within the damaged head, and then turning the screwdriver in a counterclockwise motion. The present invention is also designed to provide increased engagement between the screwdriver and the screw head, but the present invention is not specifically designed to work with damaged screw heads and instead has a much broader range of application.

Another such device is U.S. Pat. No. 4,325,153 to Finnegan, which discloses a combined screwdriver and boring apparatus having an elongated tip adapted to enter a hole in a complimentary slotted screw head and downwardly tapered cutting edges. Finnegan provides a device that is capable of pre-drilling a hole, holding the screw within the pre-drilled hole, and then screwing the screw therein. The protrusions of the present invention extend perpendicularly from the blade faces, not along the axis of the screwdriver shank as in Finnegan. Furthermore, the present invention is not adapted to pre-drill holes for the screws.

U.S. Pat. No. 6,595,730 to Bergamo and U.S. Published Patent Application Publication No. 2008/0105092 to Chen both disclose a bit for removing damaged screws comprising a tip having diametrically opposed scraping grooves. The scraping grooves are designed to dig into the metal of a deformed screw head, thereby making it easier for the bit to engage in the slot of a deformed screw head. Like Vickio, Bergamo and Chen are specifically designed to remove screws having damaged heads, however the present invention is designed to improve one's ability to both screw in and remove screws regardless of whether they are damaged or not. Additionally, the present invention provides protrusions that extend perpendicularly from the blade faces of the screwdriver, not longitudinally-extending scraping recesses along the tip of the device.

A final such device is Published U.S. Published Patent Application Publication No. 2012/0325056 to Kozak, which discloses a bit for removing a broken fastener comprising a tip having a plurality of nonlinear cutting edges extending radially therefrom. The cutting edges allow the bit to cut into the damaged fastener head when the bit is rotated in an opposite direction from the fastener's direction of engagement. In Kozak, the means to engage with the screw head are radially extending cutting edges, whereas the present invention provides protuberances extending perpendicularly from the substantially flat blade surfaces.

The present invention provides a novel screwdriver having a plurality of protrusions extending perpendicularly from the blade faces. The protrusions allow the user to generate additional friction between the screwdriver and the screw head, thereby preventing the screwdriver from slipping therefrom when rotated by the user. The protrusions help to ensure that the blade of the screwdriver is bearing evenly across the interior surface of a screw head. The protrusions can come in a number of different configurations, including ridges disposed at various locations along the blade surface and bumps. The present invention substantially diverges in design elements from the prior art and consequently it is clear that there is a need in the art for an improvement to existing screwdriver or drill bit devices. In this regard the instant invention substantially fulfills these needs.

### SUMMARY OF THE INVENTION

In view of the foregoing disadvantages inherent in the known types of screwdrivers now present in the prior art, the present invention provides a new no-slip screwdriver wherein the same can be utilized for providing convenience for the user when installing or removing screws from material or articles.

It is therefore an object of the present invention to provide a new and improved no-slip screwdriver device that has all of the advantages of the prior art and none of the disadvantages.

It is another object of the present invention to provide a no-slip screwdriver that does not slip or skid during use.

Another object of the present invention is to provide a no-slip screwdriver that has a design that increases the friction between the screwdriver blade and the fastener head.

Another object of the present invention is to provide a no-slip screwdriver that has a plurality of different configurations for the protrusions.

Yet another object of the present invention is to provide a no-slip screwdriver that is provided in both flathead and Phillips head configurations.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the present invention.

FIGS. 2A-D show perspective views of various embodiments of a flathead blade portion of the present invention.

FIGS. 3A-D show side profile views of various embodiment of a flathead blade portion of the present invention placed within a screw head.

FIG. 4 shows a perspective view of an embodiment of the present invention in use.

FIGS. 5A-D show perspective views of various embodiments of a Phillips head blade portion of the present invention.

### DETAILED DESCRIPTION OF THE INVENTION

Reference is made herein to the attached drawings. Like reference numerals are used throughout the drawings to depict like or similar elements of the no-slip screwdriver. For the purposes of presenting a brief and clear description of the present invention, the preferred embodiment will be discussed as used for installing screws into or removing screws from material or an article. The figures are intended for representative purposes only and should not be considered to be limiting in any respect.

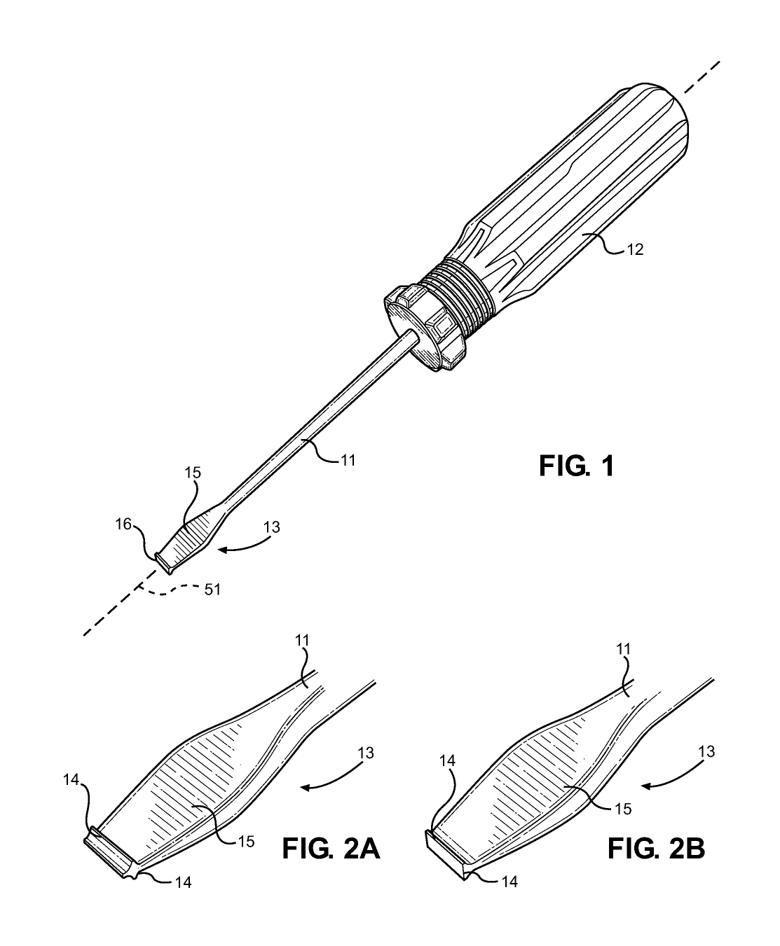

Referring now to FIG. 1, there is shown a perspective view of the present invention. The present invention comprises a screwdriver having a shank 11 with a first end and a second end, a handle 12 disposed on said first end, and a blade 13 extending from said second end. The shank 11 may be composed of any material commonly known in the prior art of screwdrivers, such as steel. The shank 11 is substantially cylindrical, hexagonal, or other another shape. When in use, the user applies rotational force about the longitudinal axis 51 extending through the shank 11 to cause the protrusions extending from the blade faces 15 to bear against the interior walls of the screw head.

The handle 12 is aligned with and adapted to rotate about the axis of rotation 51 of the shank 11. The handle 12 is constructed from hard plastic, or another material know in the prior art of screwdrivers, and is secured to the shank 11 in any appropriate manner. For example, the handle 12 may have a cavity adapted to accept the first end of the shank 11 and hold the shank 11 securely therein. The handle 12 may have a roughly cylindrical or hexagonal design, or any other shape, in order to accommodate a human hand. The handle 12 may further have a surface composed of a non-slip material.

The blade 13 is integrally formed with the shank 11 and comprises a tapered portion that extends from the second end of the shank 11. The blade 13 has a plurality of blade faces 15 and a tip 16. The tip 16 of the blade 13 has a plurality of protrusions extending therefrom. The present invention may be provided as either a flathead or a Phillips head screwdriver. The flathead embodiments have two substantially flat opposing blade faces 15 and the Phillips head embodiments have eight blades faces 15 arranged in four sets of perpendicularly-aligned pairs.

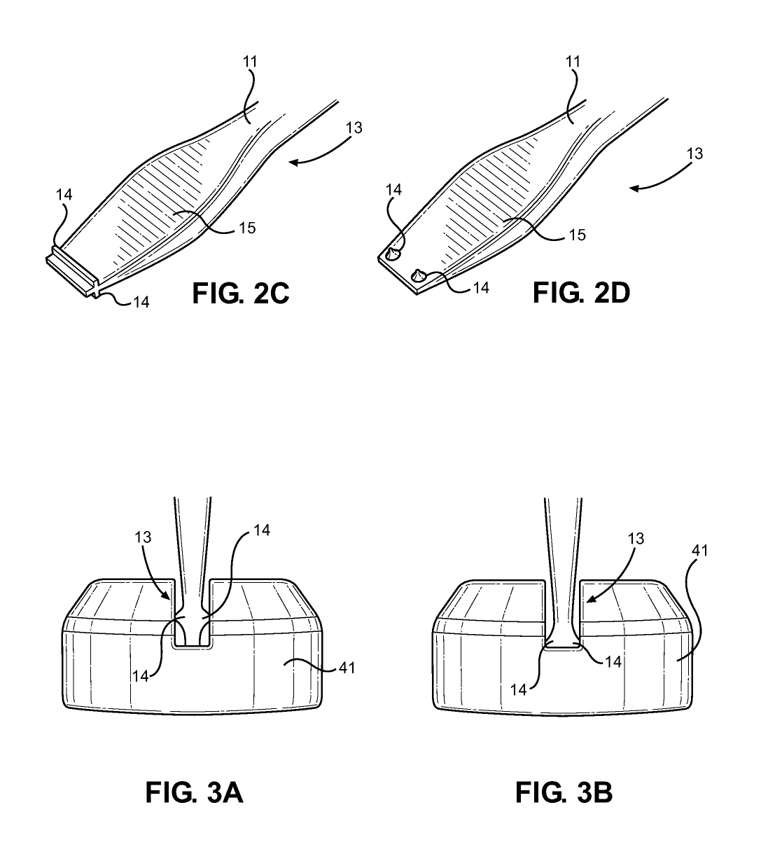

Referring now to FIGS. 2A, 2B, 2C, and 2D, there are shown perspective views of various embodiments of the present invention. The present invention comprises various types of protrusions 14 extending from the blade faces 15 of the present no-slip screwdriver. The protrusions 14 are disposed across the blade faces 15 and extend perpendicularly therefrom. Because the blade 13 extends axially along the axis of rotation of the present screwdriver, the protrusions 14 are also aligned perpendicularly to the axis of rotation. The protrusions 14 and the blade 13 are composed of the same material as the shank 11, preferably hardened steel.

The protrusions 14 prevent the present invention from slipping when in use tightening or loosening screws because when the present screwdriver is being turned, the protrusions 14 bear against the interior walls of the screw head, holding the screwdriver blade 13 in place within the screw head and preventing it from slipping therefrom. As soon as the rotational force applied by the user to the screw head through the screwdriver is removed, the user may withdraw the present invention from the screw head in the same manner as a normal screwdriver. A traditional screwdriver lacking the novel protrusions 14 herein described is more apt to slip or skip when in use because its blade 13 portion does not bear against the entirety of the interior walls of the screw head groove, which allows the screwdriver blade 13 to shift therein, potentially resulting in slipping or skipping.

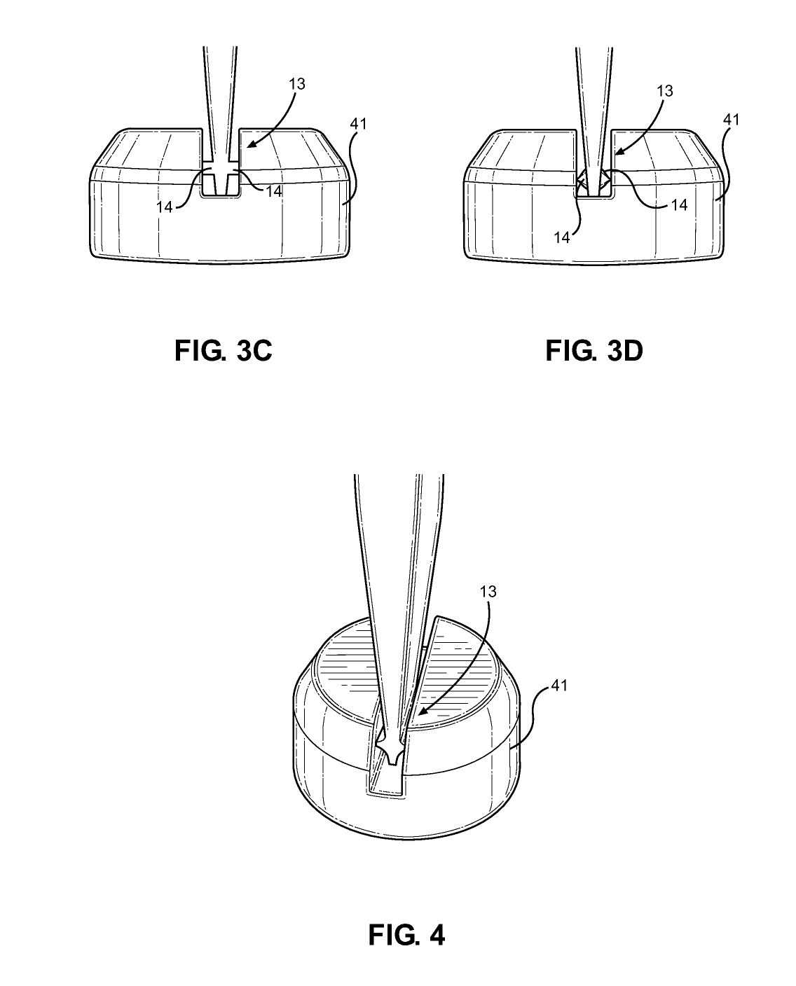

The protrusions 14 are provided in a number of different configurations, including ridges and nubs, and may have beveled, rounded, or pointed edges. The main controlling factors for the configuration of the protrusions 14 is that they must be low enough on the blade face 15, i.e. close to the tip of the blade 13, such that the protrusion are both below the level of the top surface of the screw head and contained within the grooves of the screw head, as shown in FIGS. 3A-D. If the protrusions 14 were disposed too high on the blade face 15, they would be unable to bear against the interior wall of the screw head's grooves. Furthermore, the protrusions 14 are designed such that they do not extend away from the blade face 15 so far that they prevent the present invention from being inserted within the grooves of the screw head. However, no claim is made as to the exact orientation or height of the protrusions 14 because the present no-slip screwdriver is provided in a variety of configurations adapted to screw heads of different sizes and types.

The protrusions 14 may come in a number of different configurations. FIGS. 2A, 2B, 2C, and 2D show a number of potential different designs, but are not intended to be limiting in any way. FIGS. 2A, 2B, and 2C depict an embodiment where the protrusions 14 comprise a ridge disposed along the blade face 15. In FIGS. 2A and 2C the ridge is separated a short distance from the tip of the blade 13, creating a roughly cruciform shape when viewed from a side profile view. In FIG. 2B the ridge is disposed directly across the tip of the blade 13, creating a roughly triangular shape at the tip of the blade 13 when viewed from a side profile view. The ridge protrusions extend across the entire blade face 15 in a substantially straight fashion. The height of the ridge protrusion 14 is variable depending upon the exact specifications of the embodiment, but it is not so high that it blocks the blade 13 from being inserted into the groove of the screw head. The height of the protrusions 14 effectively increases the width of the blade 13, when viewed from a side profile perspective. The ridge protrusions 14 or sets of nub protrusions 14 extend from both of the opposing blade faces 15 in opposite directions from each other, so that they can bear against the opposing interior walls of the screw head.

FIG. 2C shows an alternate embodiment of the present invention where the protrusions 14 comprise a plurality of nubs. The nubs are horizontally aligned across the blade faces 15 to ensure an even bearing force against the interior walls of the groove of the screw head. Like the previously discussed embodiments, the height of the nubs is not so high that the blade 13 cannot be inserted into the screw head and the nubs extend from the opposing blade faces 15 in opposing directions.

Referring now to FIGS. 3A, 3B, 3C, and 3D, there are shown side profile views of various embodiments of the present invention placed within a screw head. The present invention can be provided in embodiments having different types of protrusions 14, but all of the protrusions 14 share a common characteristic in that they effectively increase the width of the blade 13 of the present no-slip screwdriver so that the blade 13 is bearing against the opposing interior sidewalls of the groove of the screw head 41 at all times. The various configurations of the present invention reduce the amount of movement the blade 13 of the screwdriver can make within the screw head 41, which reduces the amount of slipping or skidding while the present invention is in use.

Referring now to FIG. 4, there is shown a perspective view of the present invention in use. The present invention is used the same as a traditional screwdriver, i.e. the blade 13 of the device is placed within the screw head 41 and rotational force is applied by the user in either a clockwise or counterclockwise direction to tighten or loosen the screw. The present invention prevents the blade 13 of the screwdriver from slipping or skidding from the screw head when in use, which increases work efficiency and lessens any possibility for damage to the screw head or surrounding material.

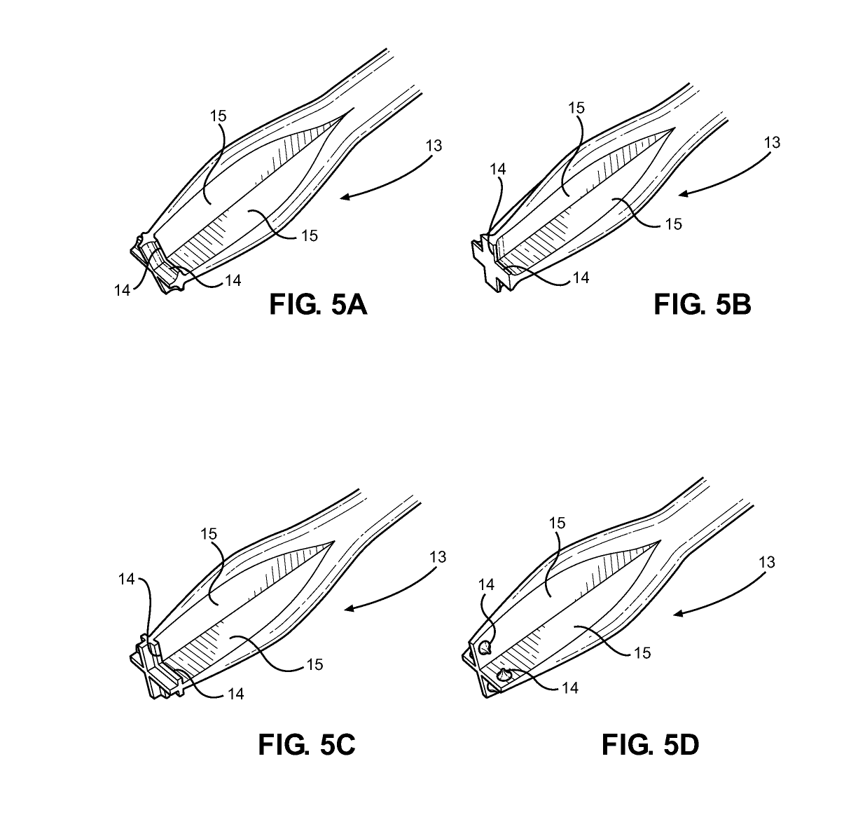

Referring now to FIGS. 5A, 5B, 5C, and 5D, there are shown perspective views of various embodiments of a Phillips head blade portion of the present invention. The present invention may be provided in Phillips head embodiments, in addition to flathead embodiments. The principals remain the same between the Phillips head and the flathead embodiments, except that the flathead embodiments have eight blade faces 15, rather than two. The blade faces 15 are arranged in four sets of perpendicular blade faces 15. Each blade face 15 has protrusions 14 extending perpendicularly therefrom, so that they may bear against the interior walls of the screw head.

Overall, the present invention provides a novel screwdriver that has protrusions from the blade faces that reduce slipping and skidding of the screwdriver blade from the screw head. The protrusions act to bear against the interior walls of the screw head, thereby locking the blade within place in the screw head. The protrusions do not interfere with the ability to remove the blade from the screw head and in all other ways the present invention performs just as a traditional screwdriver.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A screwdriver, comprising:
a shank having a first end and a second end;
a handle mounted to said first end of said shank;
a blade having a plurality of substantially flat faces and a tip, said blade extending from said second end of said shank;
a plurality of protrusions extending perpendicularly from said blade faces and adapted to bear against interior walls of grooves of a screw head when rotational force is applied to said shank.

2. The screwdriver of claim 1, wherein said protrusions comprise ridges extending across the distal ends of the blade faces forming a tip having a substantially triangular configuration.

3. The screwdriver of claim 2, wherein said protrusions are pointed.

4. The screwdriver of claim 2, wherein said protrusions are rounded.

5. The screwdriver of claim 1, wherein said protrusions comprise ridges extending across said blade faces forming a tip having a substantially cruciform configuration.

6. The screwdriver of claim 5, wherein said protrusions are pointed.

7. The screwdriver of claim 5, wherein said protrusions are rounded.

8. The screwdriver of claim 1, wherein said protrusions comprise bumps.

9. The screwdriver of claim 1, wherein said blade faces number two.

10. The screwdriver of claim 1, wherein said blade faces number eight.
